(19) United States
(12) Patent Application Publication
(10) Pub. No.: US 2011/0031367 A1
(43) Pub. Date: Feb. 10, 2011

(54) HANGER ASSEMBLY FOR CEILING FAN

(75) Inventor: CLIFF WANG, Taichung City (TW)

Correspondence Address: MICHAEL WINFIELD GOLTRY, 4000 N. CENTRAL AVENUE, SUITE 1220, PHOENIX, AZ, 85012, US

(73) Assignee: AIR COOL INDUSTRIAL CO., LTD, TAICHUNG CITY (TW)

(21) Appl. No.: 12/537,734

(22) Filed: Aug. 7, 2009

(51) Int. Cl. F16M 13/02

(52) U.S. Cl. 248/343

(57) ABSTRACT

A hanger assembly for depending a ceiling fan from an overhead includes a hanger bracket securable to an overhead support. A down rod suspended from the hanger bracket has a lower end adapted for engagement with the ceiling fan. A canopy has a central opening through which the down rod is received and an upper rim which receives the hanger bracket. The upper rim of the canopy is secured to the hanger bracket by a plurality of screws having heads exposed on the outside of the upper rim of the canopy. A rim cover which fits over and encapsulates the screw heads is engagable with the heads of the screws.

### FIELD OF THE INVENTION

This invention relates to ceiling fans.

More particularly, the present invention relates to hanger assemblies for depending a ceiling fan from an overhead support device.

In a further and more specific aspect, the instant invention concerns an aesthetically enhanced hanger bracket of the above type.

### BACKGROUND OF THE INVENTION

Ceiling fans are conventionally suspended from a ceiling by means of a hanger assembly. A known hanger assembly includes a hanger bracket securable to an overhead support member such as an electrical junction box. The hanger bracket includes slots which receive screws there through for engagement with the flanges of the junction box.

A ball socket is formed into the top of the hanger bracket. A ball, supported in the ball socket for swivel motion, supports a depending down rod. Attachment means, integral with the lower end of the down rod, are secured to the fan. A canopy, generally in the shape of an inverted dome, includes a central opening through which the down rod passes and an upper rim which encircles the peripheral sidewall of the hanger bracket.

The rim of the canopy is secured to the hanger bracket by means of a plurality of screws which extend through openings in the rim of the canopy and threadedly engage within the hanger bracket. The heads of the screws reside external of the canopy.

It is recognized that the exposed screw heads detract from the aesthetics of the hanger assembly. Accordingly, the prior art has provided a rim cover which encapsulates the screw heads. In accordance with one embodiment, the prior art has provided a rim cover having a plurality of J-shaped recesses formed into the inside surface which receive the heads of the screws. In accordance with another embodiment, the rim cover is fabricated of a resilient material. An annular groove formed in the inner surface of the resilient cover receives the screw heads in snap engagement.

While encasing the screw heads, the rim covers provided by the prior art have not proven to be entirely satisfactory. Forming a J-shaped groove into the inner surface of the rim cover requires that the rim cover be extraordinarily thick. Also forming such grooves requires extraneous and relatively expensive manufacturing. Fabricating the rim cover of a resilient material detracts from the desired aesthetics. It is also noted that the screw heads tend to be relatively small with rounded exposed surfaces which do not adequately engage the prior art rim covers.

It would be highly advantageous, therefore, to remedy the foregoing and other deficiencies inherent in the prior art.

### SUMMARY OF THE INVENTION

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and having an upper rim, mounting screws each extending through the rim of the canopy and engaged to the hanger bracket and having a head residing external of the rim of the canopy, and a rim cover for encapsulating the heads of the screws and securable with respect to the rim of the canopy. The rim cover has opposed fingers each having a lower end affixed to the rim cover and an opposing upper end, a notch between the opposed upper and lower ends, and opposed front and rear faces. There is a first gap between the opposed fingers extending from and between the upper ends of the fingers and the lower ends of the fingers, and a second gap between the rear faces of the fingers and the rim cover. The fingers are flexurally resilient in reciprocal directions relative to each other to admit the head of one of the screws into the first gap and into the notches formed in the fingers to embrace and secure the head of the screw. The fingers are also flexurally resilient in reciprocal directions relative to the rim cover. The rim cover includes an upper edge receivable in juxtaposition with the ceiling. The rim cover also includes an in turned lower edge receivable in juxtaposition with the canopy.

According to the principle of the invention, a hanger assembly for depending a fan from an overhead support includes a mounting bracket securable to the overhead support; a down rod to be suspended from the mounting bracket and having a lower end engagable with the fan; a canopy having a central opening for receiving the down rod there through and having an upper rim, mounting screws each extending through the rim of the canopy and engaged to the hanger bracket and including a head residing external of the rim of the canopy, and a rim cover for encapsulating the heads of the screws and securable with respect to the rim of the canopy. The rim cover has opposed fingers each having a lower end affixed to the rim cover and an opposing upper end, a notch between the opposed upper and lower ends, and opposed front and rear faces. There is a gap between the rear face of each of the fingers and the rim cover. The fingers are flexurally resilient to admit the heads of the screws into the notches of the respective fingers to embrace and secure the heads of the screws. The fingers are also flexurally resilient in reciprocal directions relative to the rim cover. The rim cover includes an upper edge receivable in juxtaposition with the ceiling. The rim cover also includes an in turned lower edge receivable in juxtaposition with the canopy.

According to the principle of the invention, a hanger assembly for depending a fan from an overhead support includes a mounting bracket securable to the overhead support, a down rod to be suspended from the mounting bracket and having a lower end engagable with the fan, a canopy having a central opening for receiving the down rod there through and having an upper rim, and opposed mounting screws each extending through the rim of the canopy and engaged to the hanger bracket and including a head residing external of the rim of the canopy. The heads of the screws each have a side. Further to the hanger assembly is a rim cover for encapsulating the heads of the screws, and which is securable with respect to the rim of the canopy. The rim cover has opposed fingers each having a lower end affixed to the rim cover and an opposing upper end, a notch between the opposed upper and lower ends, and opposed front and rear faces. There is a gap between the rear face of each of the fingers and the rim cover. The fingers are flexurally resilient to concurrently admit the sides of the heads of the respective screws into the notches of the respective fingers to embrace and secure the heads of the screws. In one embodiment, the notches are directed away from each other and the sides of the screws are outer sides of the screws. In another embodiment, the notches are directed toward each other and the sides of the screws are inner sides of the screws. The fingers are also flexurally resilient in reciprocal directions relative to the rim cover. The rim cover includes an upper edge receivable in juxtaposition with the ceiling. The rim cover also includes an in turned lower edge receivable in juxtaposition with the canopy.

### BRIEF DESCRIPTION OF THE DRAWINGS

Referring to the drawings:

FIG. 1 is a partially exploded perspective view of a ceiling fan hanger assembly constructed in accordance with the principles of the instant invention;

FIG. 2 is a side elevation view of the hanger assembly of FIG. 1 as it would appear fully assembled;

FIG. 3 is a top plan view of the fully assembled hanger assembly of FIG. 2;

FIG. 4 is a top plan view of a rim cover of the ceiling fan hanger assembly of FIG. 1;

FIG. 5 is an enlarged vertical sectional view showing an embodiment of an engagement assembly for engaging a rim cover to a canopy of the ceiling fan hanger assembly of FIG. 1;

FIG. 6 is an enlarged sectional view taken along line 6-6 of FIG. 5;

FIG. 7 is a sectional view taken along line 7-7 of FIG. 6;

FIG. 8 is a partially exploded perspective view of an alternate embodiment of a ceiling fan hanger assembly constructed in accordance with the principles of the instant invention;

FIG. 9 is a top plan view of the fully assembled hanger assembly of FIG. 8;

FIG. 10 is a top plan view of a rim cover of the ceiling fan hanger assembly of FIG. 8;

FIG. 11 is an enlarged vertical sectional view showing an embodiment of an engagement assembly for engaging a rim cover to a canopy of the ceiling fan hanger assembly of FIG. 8;

FIG. 12 is an enlarged sectional view taken along line 12-12 of FIG. 11;

FIG. 13 is a fragmented side elevation view illustrating a rim cover clamped to a canopy of the ceiling fan hanger assembly of FIG. 8;

FIG. 14 is a partially exploded perspective view of yet another alternate embodiment of a ceiling fan hanger assembly constructed in accordance with the principles of the instant invention;

FIG. 15 is a top plan view of the fully assembled hanger assembly of FIG. 14;

FIG. 16 is a top plan view of a rim cover of the ceiling fan hanger assembly of FIG. 14;

FIG. 17 is an enlarged vertical sectional view showing an embodiment of an engagement assembly for engaging a rim cover to a canopy of the ceiling fan hanger assembly of FIG. 14;

FIG. 18 is an enlarged sectional view taken along line 18-18 of FIG. 17; and

FIG. 19 is a fragmented side elevation view illustrating a rim cover clamped to a canopy of the ceiling fan hanger assembly of FIG. 8.

### DETAILED DESCRIPTION

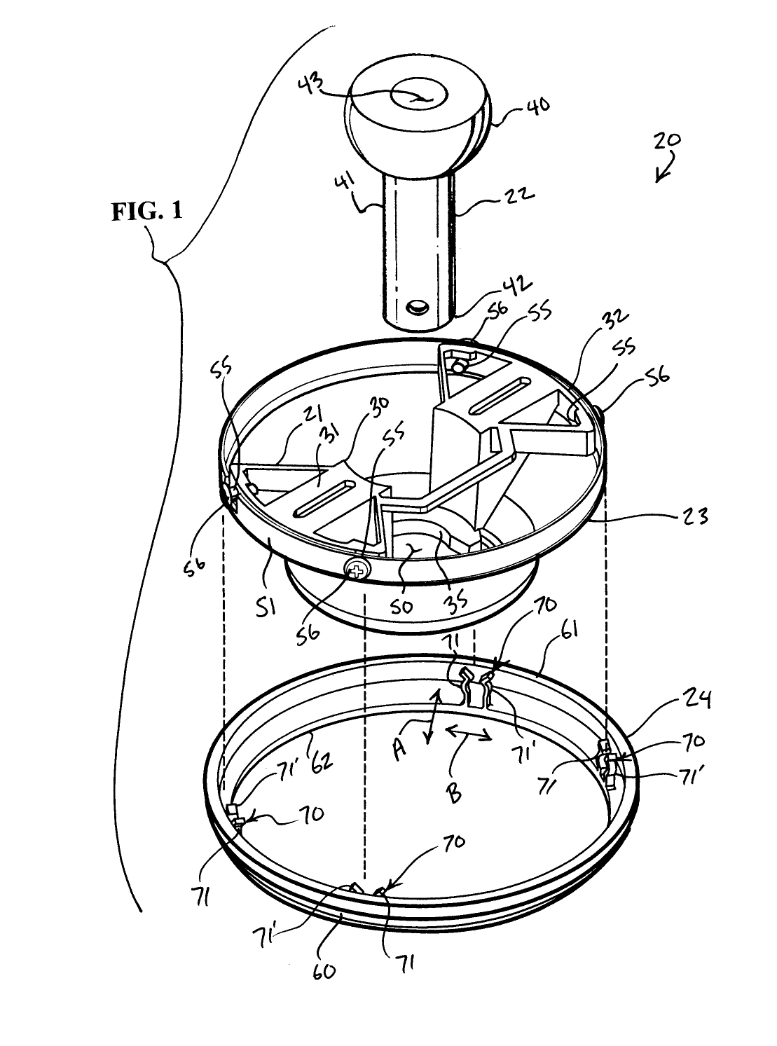

Turning now to the drawings, in which like reference characters indicate corresponding elements throughout the several views, attention is first directed to FIG. 1 in which is seen a ceiling fan hanger assembly, incorporating the teachings of the instant invention and generally designated by reference character 20. Hanger assembly 20 includes hanger bracket 21, down rod 22, canopy 23, and rim cover 24.

Hanger bracket 21 includes base 30, upper surface 31 and peripheral sidewall 32. Spherical ball socket 35 is formed into bracket 21 at a generally central location. Slots 36 extending through base 30 accommodate mounting screws which pass through slots 36 and threadedly engage an overhead support member. Although the overhead support member is not specifically illustrated, those skilled in the art will readily appreciate that conventional overhead support members include electrical junction boxes, especially devised struts and beams, all of which are considered to be integral with a ceiling. Further, when hanger bracket 21 is secured to the overhead support member, upper surface 31 abuts the ceiling.

Down rod 22 includes ball 40 which is to be matingly received within socket 35 in a conventional manner. Shaft 41, having lower end 42, depends from ball 40. It will be readily understood by those skilled in the art that the lower terminal portion of shaft 41 adjacent lower end 42 can be threaded or otherwise configured for securement to a conventional ceiling fan. Bore 43 extending longitudinally through ball 40 and shaft 41 accommodate the electrical wires which extend from a junction box to the fan.

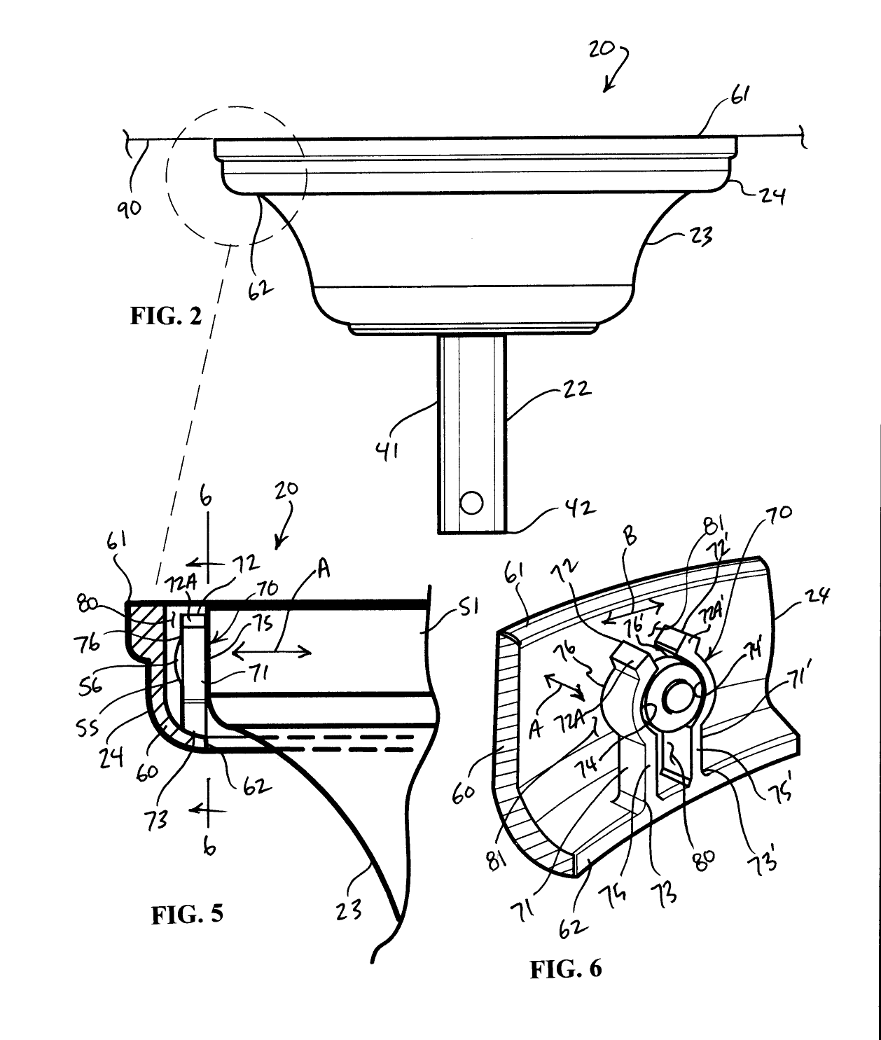

Canopy 23 is generally in the shape of an inverted dome as illustrated in FIG. 1 and FIG. 2. Referencing FIG. 1, canopy 23 includes a generally central opening 50 for receiving shaft 41 there through. Canopy 23 also includes an upper rim 51 sized and shaped to receive peripheral sidewall 32 of hanger bracket 21 therein.

A plurality of openings extend through upper rim 51 of canopy 23, which are spaced to align with threaded bores in hanger bracket 21. A screw 55 extends through each of the openings through upper rim 51 and threadedly engaged with a respective threaded bore in peripheral sidewall 32 of hanger bracket 21. As illustrated in FIG. 1 and FIG. 3, a head 56 of each respective screw 55 resides externally of upper rim 51 of canopy 23.

Rim cover 24, illustrated in further detail in FIG. 2, FIG. 3, and FIG. 4, includes sidewall 60 having upper edge 61 and lower edge 62 (lower edge 62 not illustrated in FIG. 3). Rim cover 34 is sized to extend about and encapsulate heads 56 of screws 55. A plurality of clamps 70 are formed inwardly with respect to sidewall 60.

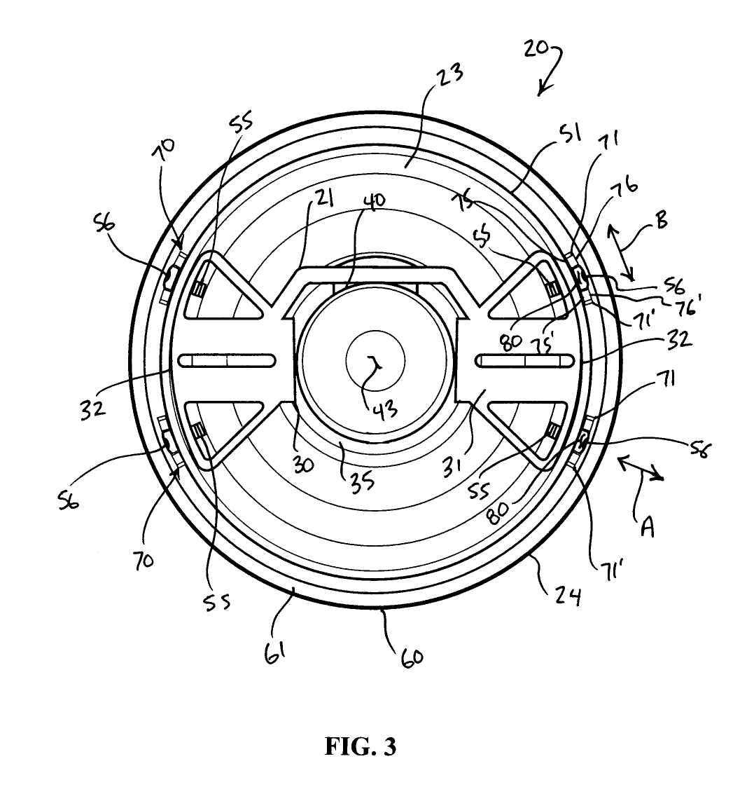

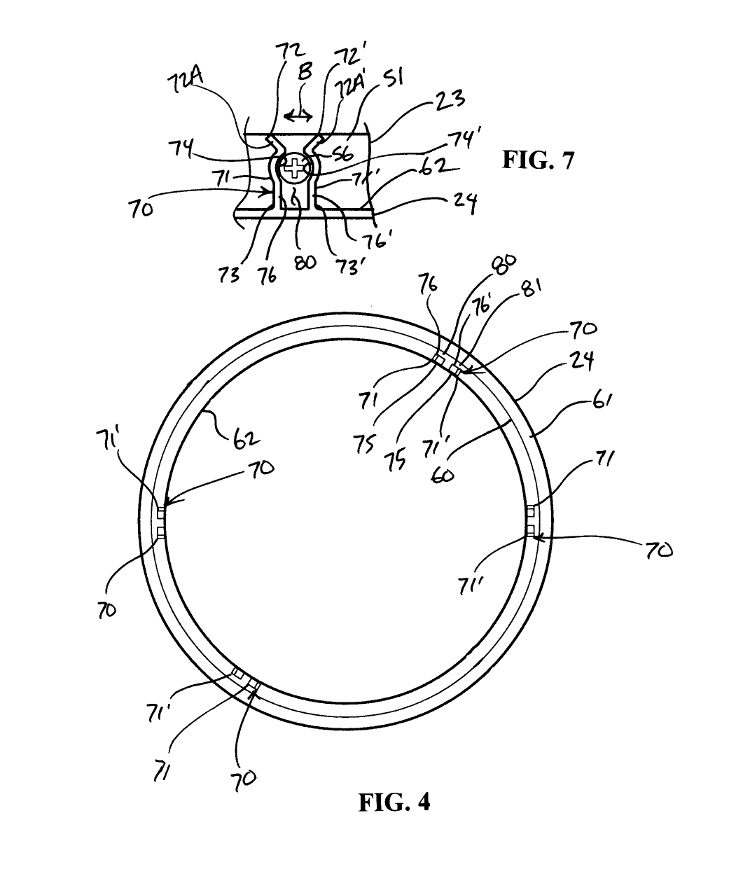

Clamps 70 are fabricated of a resilient material. Clamps 70 are identical to each other and each include, as shown in FIG. 6 and FIG. 7, opposed and confronting upstanding fingers 71 and 71′ integrally formed with sidewall 60. Fingers 71 and 71′ are the mirror image of one another and are substantially coextensive. Fingers 71 have upper ends 72 and 72′ and opposed lower ends 73 and 73′, respectively, affixed to sidewall 60 of rim cover 24 just inboard of lower edge 62. Fingers 71 and 71′ project upwardly from lower edge 62 and terminate with upper ends 72 and 72′, respectively, which upper ends 72 and 72′ are directed toward upper edge 61.

Fingers 71 and 71′ are spaced apart from each other, in which there is a gap 80 therebetween extending from and between upper ends 72 and 72′ of fingers 71 and 71′ to lower ends 73 and 73′ of fingers 71 and 71′. Notches 74 and 74′ are formed in fingers 71 and 71′, respectively. Notch 74 is formed between upper and lower ends 72 and 73 of finger 71, and notch 74′ is formed between upper and lower ends 72′ and 73′ of finger 71′. Notches 74 and 74′ oppose and face inwardly toward one other and are substantially equal in size. Finger 71 has opposed front and rear faces 75 and 76, and finger 71′ has opposed front and rear faces 75′ and 76′. Rear faces 76 and 76′ face sidewall 60, in which there is a gap 81 therebetween rear face 76 and sidewall 60 and a gap 81′ therebetween rear face 76′ and sidewall 60.

Upper ends 72 and 72′ of fingers 71 and 71′ are formed with out turned portions 72A and 72A′, and are directed inwardly with respect to each other or are otherwise in turned with respect to each other, in which the width of gap 80 between upper ends 72 and 72′ of fingers 71 and 71′ is narrowed with respect to the width of gap 80 between notches 74 and 74′. Out turned portions 72A and 72A′ are out turned with respect to notches 74 and 74′, respectively. Fingers 71 and 71′ are flexurally resilient in reciprocal directions relative to sidewall 60 of rim cover 24 as indicated by the double arrowed line A in FIG. 1, FIG. 3, FIG. 4, FIG. 5, and FIG. 6, and are flexurally resilient in reciprocal directions relative to each other as indicated by the double arrowed line B in FIG. 1, FIG. 3, FIG. 4, FIG. 6, and FIG. 7.

Referencing FIG. 3, heads 56 of screws 55 reside within the gaps 80 between fingers 71 and 71′ of the respective clamps 70, and reside within and are held within the notches 74 and 74′ in fingers 71 and 71′ of the respective clamps 70 when hanger assembly 20 is assembled and secured to an overhead support member. Accordingly, rim cover 24 is received is clamp engagement with heads 56 of screws 55 to secure rim cover 24 with respect to canopy 23. Clamps 70 are spaced apart with respect to each other, and are positioned to correspond to the positioning of the heads 56 of the respective screws 55 securing canopy 23 to hanger bracket 21, and are aligned with the heads 56 of the respective screws 55 when fitting rim cover 24 about the upper rim 51 of canopy 23. The integral formation of sidewall 60 with lower ends 73 and 73′ of fingers 71 and 71′ supporting notches 74 and 74′ is preferred, but it will be understood that lower ends 73 and 73′ of fingers 71 and 71′ can be welded to sidewall 60, adhesively affixed to sidewall 60, or rigidly affixed to sidewall 60 in other ways.

FIG. 5 and FIG. 7 illustrate head 56 of screw 55 as it would appear positioned in gap 80 between fingers 71 and 71′, positioned in notches 74 and 74′, and notches 74 and 74′ of fingers 71 and 71′ engaging and embracing head 56. The flexural nature of fingers 71 and 71′ is thus provided in such a way that fingers 71 and 71′ bias toward head 56 biasing notches 74 and 74′ toward and against head 56 of screw 55 when installed therewith for providing a clamping engagement or embracement of head 56 by and between fingers 71 and 71′, according to the principle of the invention. When rim cover 24 is clamp engaged with respect to upper rim 51 of canopy 23 such that clamps 70 are clamp engaged to the heads 56 of the respective screws 55, fingers 71 and 71′ of the respective clamps 70 are received in juxtaposition with respect to upper rim 51 of canopy 23 as shown in FIG. 3. This aspect is also illustrated in FIG. 5, which shows clamp 100 clamp engaged to head 56 of screw 55, and finger 71 of clamp 70 received in juxtaposition with respect to upper rim 51 of canopy 23.

Fingers 71 and 71′ of each clamp 70 are flexurally resilient in reciprocal directions relative to each other to admit head 56 of screw 55 into gap 80 and into notches 74 and 74′ formed in fingers 71 and 71′ to embrace and secure head 56 of screw 55. The flexural character of fingers 71 and 71′ allow them to flex outwardly and away from each other as needed for installing rim cover 24 to canopy 23 and removing rim cover 24 from canopy 24. Rim cover 24 is brought upwardly toward upper rim 51 of canopy 23 and is maneuvered to register clamps 70 with the respective heads 56 of screws 55. With respect to each clamp 70, head 56 of screw 55 is initially received against out turned portions 72A and 72A′ of fingers 71 and 71′. Through the application of an upward force, head 56 acts on out turned portions 72A and 72A′ of fingers 71 and 71′ spreading fingers 71 apart widening gap 80 between upper ends 72 and 72′ permitting head 56 to pass into gap 80 the notches 74 and 74′, in which fingers 71 and 71′ then flex inwardly with respect to each other toward the head 56 engaging notches 74 and 74′ of fingers 71 against head 56 clamping and embracing head 56 thereby clamping and securing head 56 and clamp securing rim cover 24 with respect to upper rim 51 of canopy 23.

As further seen in FIG. 2, when hanger assembly 20 is assembled and installed, upper edge 61 of rim cover 24 resides in juxtaposition with ceiling 90. Lower edge 62 of rim cover 24 is in turned to reside in juxtaposition with canopy 24 as illustrated in FIG. 2 and FIG. 5.

Hanger assembly 20 includes four screws 55 and four corresponding clamps 70 in the present embodiment. Those of ordinary skill will readily appreciate that hanger assembly 20 may incorporate any number of screws 55 to secure canopy 23 to hanger bracket 21, and that rim cover 24 may be constructed with the appropriate number of clamps 70 to correspond with whatever number of screws 55 hanger assembly 20 utilizes.

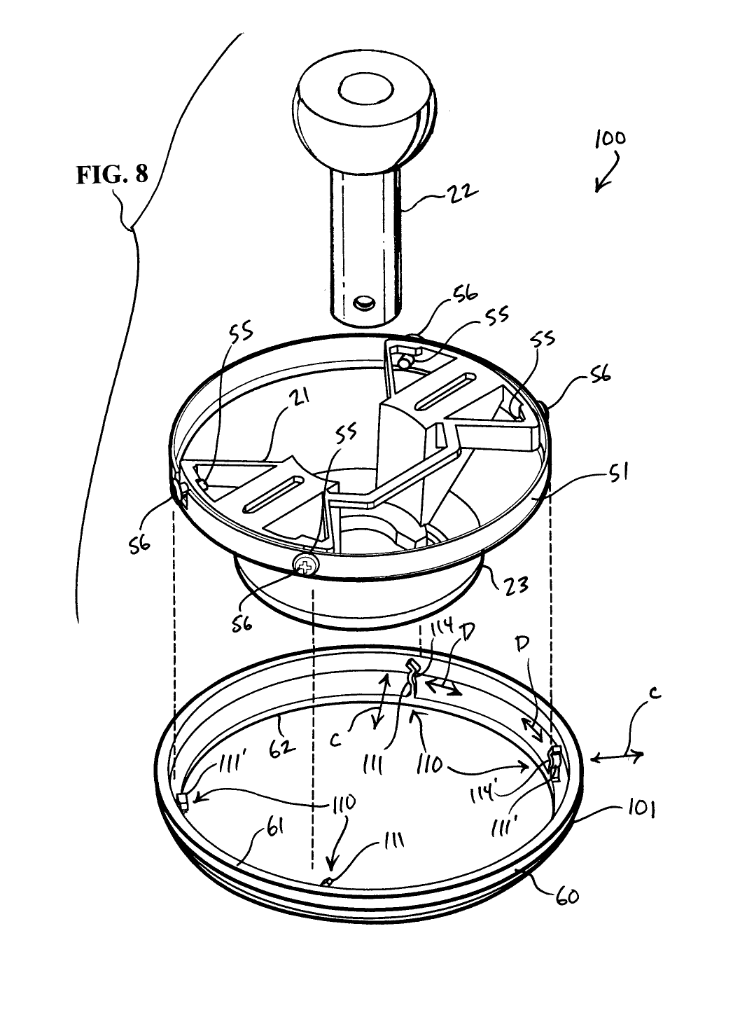

In hanger assembly 20, clamps 70 formed in rim cover 24 each relate to the head 56 of one of the respective screws 56 securing canopy 23 to hanger bracket 21. In the ensuing two alternate embodiments, the first of which is presented in FIGS. 8-13 and the second of which is presented in FIGS. 14-19, the clamps formed in the rim covers each relate to two screw heads.

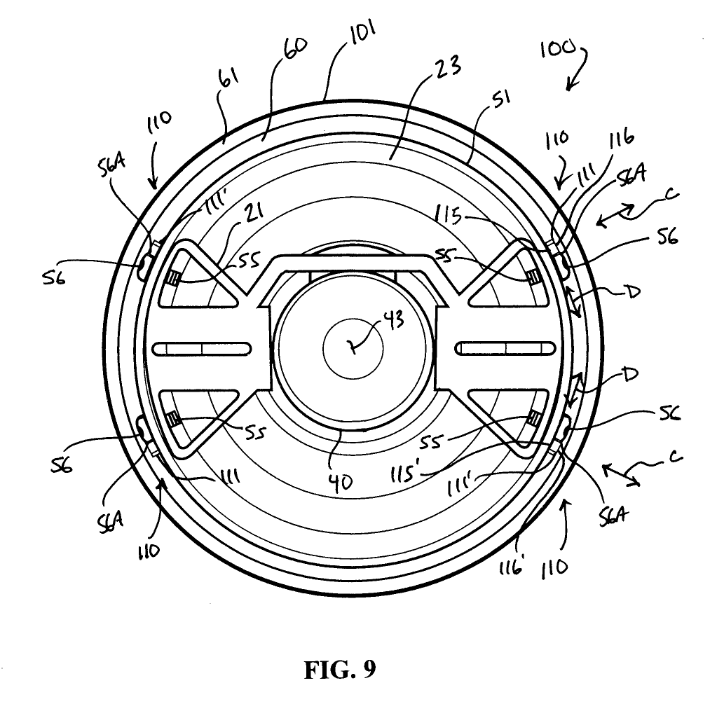

Reference is now made to FIGS. 8 and 9, in which is seen an alternate embodiment of a ceiling fan hanger assembly, incorporating the teachings of the instant invention and generally designated by reference character 100. In common with hanger assembly 20, hanger assembly 100 shares hanger bracket 21, down rod 22, canopy 23, and screws 55 formed with heads 56, and also includes an alternate embodiment of a rim cover denoted at 101. The details with respect to bracket 21, down rod 22, and canopy 23 and the assembly thereof are as in the embodiment of hanger assembly designated 20, the details of which apply equally with respect to hanger assembly 100 and will not again be discussed.

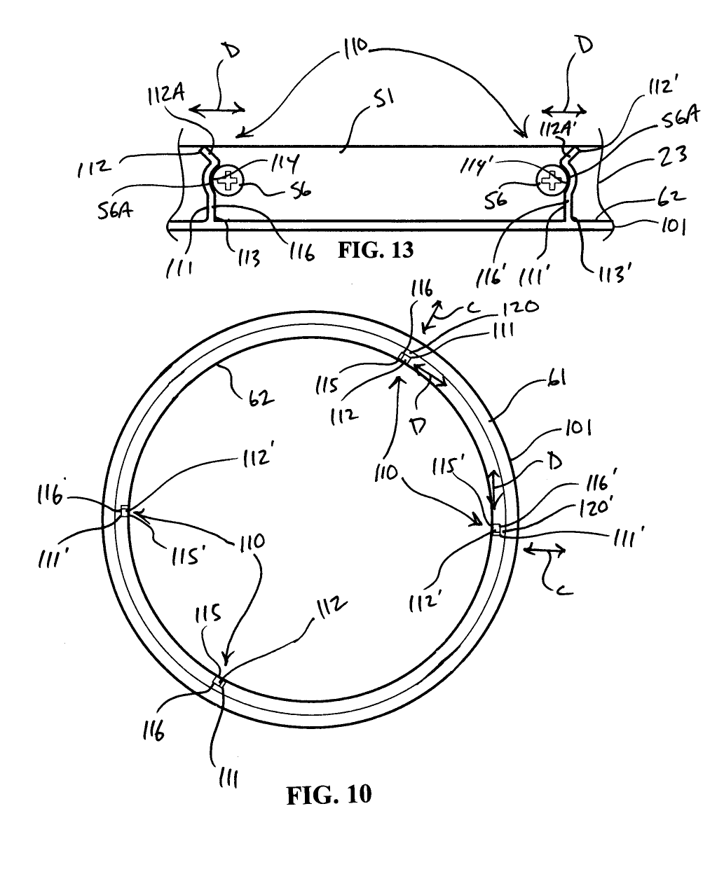

Rim cover 101, illustrated in detail in FIG. 8, FIG. 9, and FIG. 10, is common to rim cover 24 in that rim cover 100 shares upper edge 61 and lower edge 62 (lower edge 62 not illustrated in FIG. 9) and which is sized to extend about and encapsulate heads 56 of screws 55 as in hanger assembly 20. A plurality of clamps, denoted generally at 110, are formed inwardly with respect to sidewall 60 that, unlike clamps 70 in hanger bracket 20, are each configured to clamp the heads 56 of two screws 55.

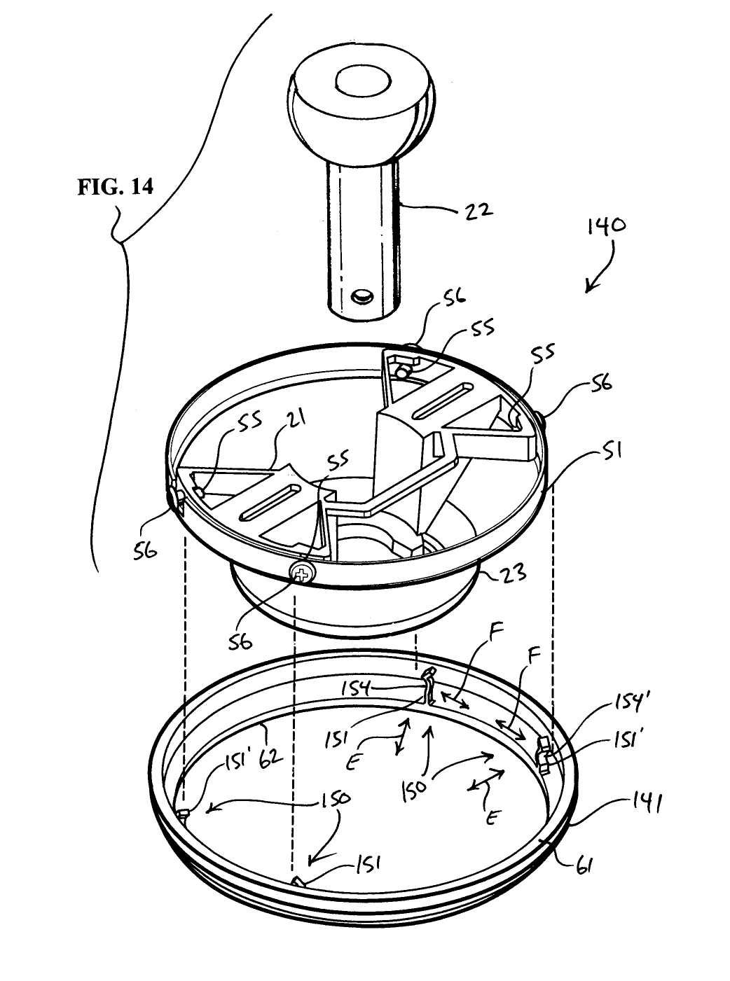

Clamps 110 are fabricated of a resilient material and are identical to each other. Referencing FIG. 13, clamps 110 each include opposed and confronting upstanding fingers 111 and 111′ integrally formed with sidewall 60. Fingers 111 and 111′ are the mirror image of one another and are substantially coextensive. Fingers 101 have upper ends 112 and 112′ and opposed lower ends 113 and 113′, respectively, affixed to sidewall 60 of rim cover 101 just inboard of lower edge 62. Fingers 111 and 111′ project upwardly from lower edge 62 and terminate with upper ends 112 and 112′, respectively, which upper ends 112 and 112′ are directed toward upper edge 61.

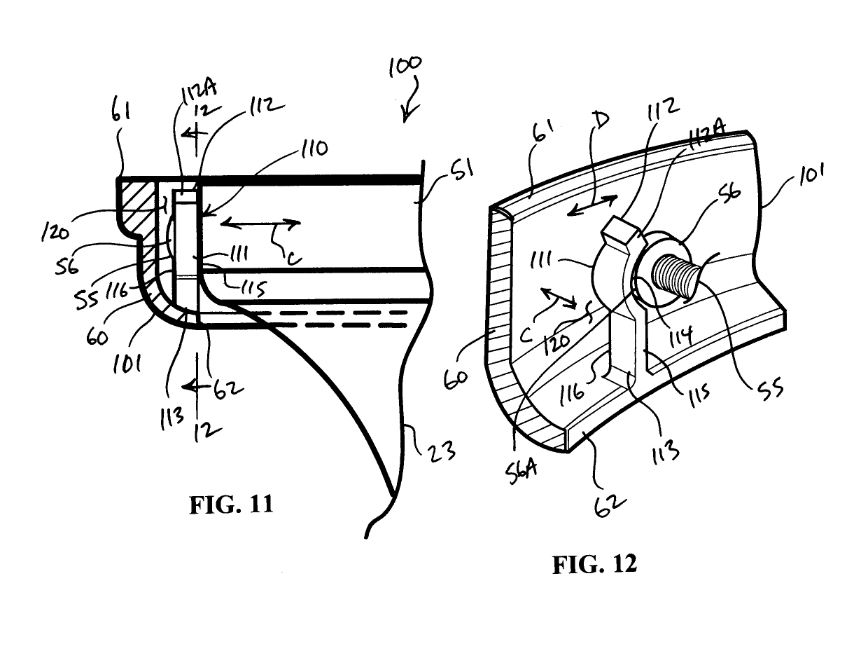

Rim cover 100 is generally circular in shape, and fingers 111 and 111′ are circumferentially spaced apart from each other and are further positioned to relate to the heads 56 of a pair of respective screws 55 securing canopy 23 to hanger bracket 21. Notches 114 and 114′ are formed in fingers 111 and 111′, respectively. Notch 114 is formed between upper and lower ends 112 and 113 of finger 111, and notch 114′ is formed between upper and lower ends 112′ and 113′ of finger 111′. Notches 114 and 114′ oppose and substantially face inwardly toward one another and are substantially equal in size. Finger 111 has opposed front and rear faces 115 and 116 denoted in FIG. 9, FIG. 11, and FIG. 12, and finger 111′ has opposed front and rear faces 115′ and 116′ denoted in FIG. 9. Rear faces 116 and 116′ face sidewall 60, in which there is a gap 120 therebetween rear face 116 and sidewall 60 illustrated in FIG. 9, FIG. 10, FIG. 11, and FIG. 12, and a gap 120′ therebetween rear face 116′ and sidewall 60 illustrated in FIG. 9 and FIG. 10.

Upper ends 112 and 112′ of fingers 111 and 111′ are formed with out turned portions 112A and 112A′. Out turned portions 112A and 112A′ are out turned with respect to notches 114 and 114′, respectively. Fingers 111 and 111′ are flexurally resilient in reciprocal directions relative to sidewall 60 of rim cover 101, each as indicated by a double arrowed line C in FIG. 8, FIG. 9, FIG. 10, FIG. 11, and FIG. 12, and are flexurally resilient in reciprocal directions substantially relative to each other, each as indicated by a double arrowed line D in FIG. 8, FIG. 9, FIG. 10, FIG. 12, and FIG. 13.

Referencing FIG. 13, heads 56 of screws 55 reside between fingers 111 and 111′ of clamp 110, and reside within and are held within the notches 114 and 114′ in fingers 111 and 111′ of clamp 110 when hanger assembly 20 is assembled and secured to an overhead support member, in which notches 114 and 114′ are applied against outer sides 56A of the heads 56 of the respective screws 55. Accordingly, rim cover 101 is received is clamp engagement with heads 56 of screws 55 to secure rim cover 101 with respect to canopy 23. Fingers 111 and 111′ are spaced apart with respect to each other, and are positioned to correspond to the positioning of the heads 56 of the respective two screws 55 securing canopy 23 to hanger bracket 21, and are aligned with the heads 56 of the respective two screws 55 when fitting rim cover 101 about the upper rim 51 of canopy 23. The integral formation of sidewall 60 with lower ends 113 and 113′ of fingers 111 and 111′ supporting notches 114 and 114′ is preferred, but it will be understood that lower ends 113 and 113′ of fingers 111 and 111′ can be welded to sidewall 60, adhesively affixed to sidewall 60, or rigidly affixed to sidewall 60 in other ways.

FIG. 13 illustrate the heads 56 of the two screws 55 positioned between fingers 111 and 111′, and the outer sides 56A of the heads 56 of the respective two screws positioned in or otherwise received by notches 114 and 114′ formed in the respective fingers 111 and 111′ engaging and embracing heads 56. FIG. 12 is an enlarged view illustrating head 56 of screw 55 located in notch 114 formed in finger 111. The flexural nature of fingers 111 and 111′ is thus provided in such a way that fingers 111 and 111′ bias toward the outer sides 56A of the respective heads 56 biasing notches 114 and 114′ toward and against the outer sides 56A of the respective heads 56 when installed therewith for providing a clamping engagement or embracement of heads 56 by and between fingers 111 and 111′, according to the principle of the invention. When rim cover 24 is clamp engaged with respect to upper rim 51 of canopy 23 such that clamps 110 are clamp engaged to the heads 56 of two screws 55, fingers 111 and 111′ of the clamp 110 are received in juxtaposition with respect to upper rim 51 of canopy 23 as illustrated in FIG. 9. This aspect is also illustrated in FIG. 5, which shows finger 111 of clamp 110 clamp engaged to head 56 of screw 55, and finger 111 of clamp 110 received in juxtaposition with respect to upper rim 51 of canopy 23.

Fingers 111 and 111′ of each clamp 110 are flexurally resilient in reciprocal directions to concurrently admit heads 56 of screws 55 between fingers 111 and 111′ and into notches 114 and 114′ formed in fingers 111 and 111′, respectively, to embrace and secure heads 56 of screws 55. The flexural character of fingers 111 and 111′ allow them to flex outwardly and away from each other as needed for installing rim cover 101 to canopy 23 and removing rim cover 101 from canopy 101. Rim cover 101 is brought upwardly toward upper rim 51 of canopy 23 and is maneuvered to register fingers 111 and 111′ with the respective heads 56 of screws 55. The heads 56 of the respective screws 55 are initially received against out turned portions 112A and 112A′ of the respective fingers 111 and 111′. Through the application of an upward force, heads 56 of the respective screws 55 act on out turned portions 112A and 112A′ of fingers 111 and 111′, respectively, spreading fingers 111 and 111′ apart from each other permitting the heads 56 of the respective screws 55 to pass between fingers 111 and 111′ to notches 114 and 114′, in which fingers 111 and 111′ then flex inwardly with respect to each other toward the outer sides 56A of the heads 56 of the respective screws 55 engaging notches 114 and 114′ of fingers 101 against the outer sides 56A of the heads 56 of the respective screws 55 clamping and embracing heads 56 between fingers 111 and 111′ thereby clamping and securing heads 56 and clamp securing rim cover 101 with respect to upper rim 51 of canopy 23.

Like hanger assembly 20 illustrated in FIG. 2, when hanger assembly 100 is assembled and installed, upper edge 61 of rim cover 101 resides in juxtaposition with the ceiling. Further, lower edge 62 of rim cover 101 is in turned to reside in juxtaposition with canopy 101 as illustrated in FIG. 11.

Those of ordinary skill will readily appreciate that hanger assembly 100 may incorporate any number of screws 55 to secure canopy 23 to hanger bracket 21, and that rim cover 101 may be constructed with the appropriate number of clamps 110 to correspond the number of screws 55 hanger assembly 100 utilizes, with the understanding that each clamp 110 relates to two heads of two screws.

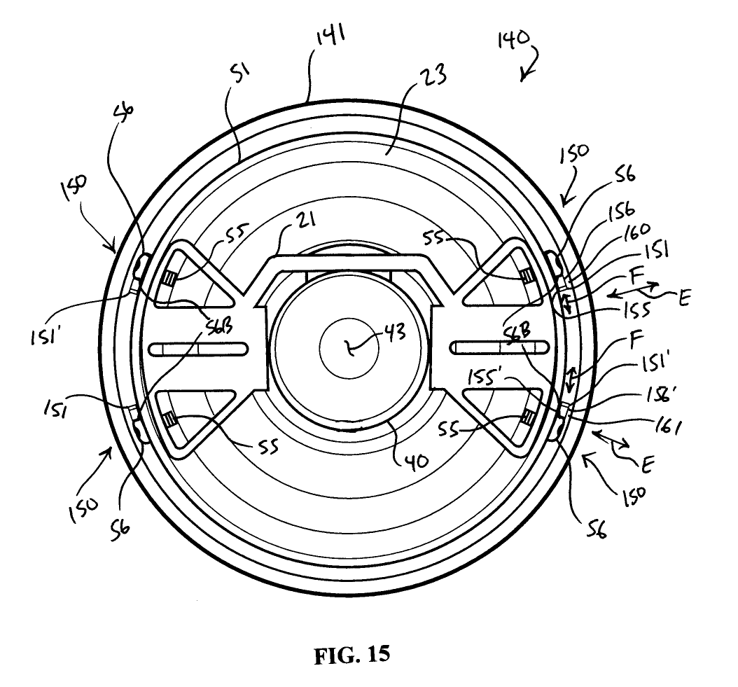

Reference is now made to FIGS. 14 and 15, in which is seen yet another alternate embodiment of a ceiling fan hanger assembly, incorporating the teachings of the instant invention and generally designated by reference character 140. In common with hanger assembly 20, hanger assembly 140 shares hanger bracket 21, down rod 22, canopy 23, and screws 55 formed with heads 56, and also includes an alternate embodiment of a rim cover denoted at 141. The details with respect to bracket 21, down rod 22, and canopy 23 and the assembly thereof are as in the embodiment of hanger assembly designated 20, the details of which apply equally with respect to hanger assembly 140 and will not again be discussed.

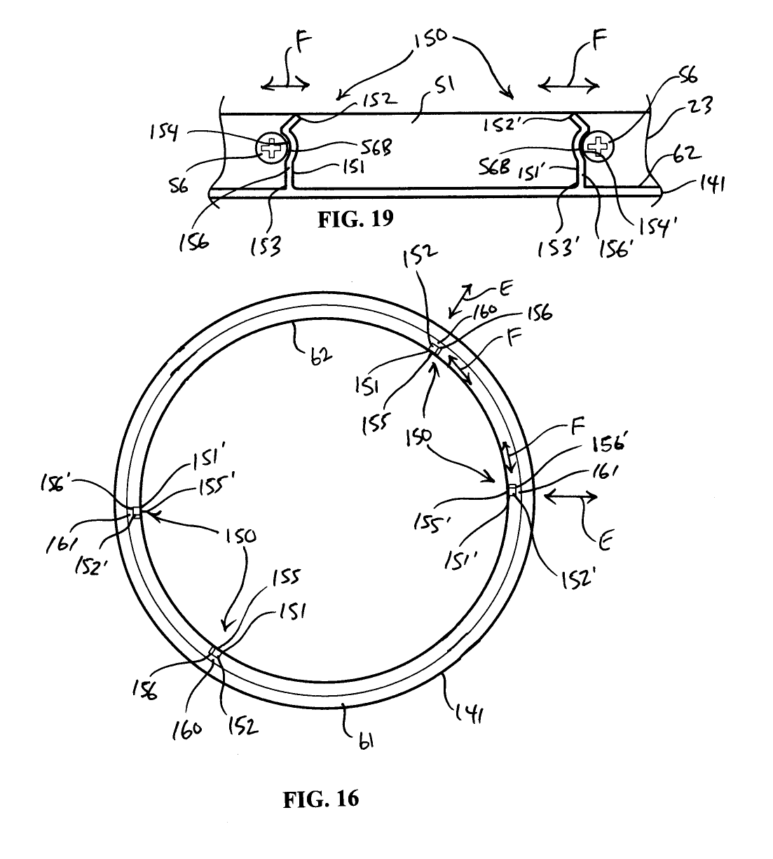

Rim cover 141, illustrated in detail in FIG. 14, FIG. 15, and FIG. 16, is common to rim cover 24 in that rim cover 140 shares upper edge 61 and lower edge 62 (lower edge 62 not illustrated in FIG. 15) and which is sized to extend about and encapsulate heads 56 of screws 55 as in hanger assembly 20. A plurality of clamps, denoted generally at 150, are formed inwardly with respect to sidewall 60 that, unlike clamps 70 in hanger bracket 20, are each configured to clamp the heads 56 of two screws 55.

Clamps 150 are fabricated of a resilient material and are identical to each other. Referencing FIG. 19, clamps 150 each include opposed and confronting upstanding fingers 151 and 151′ integrally formed with sidewall 60. Fingers 151 and 151′ are the mirror image of one another and are substantially coextensive. Fingers 141 have upper ends 152 and 152′ and opposed lower ends 153 and 153′, respectively, affixed to sidewall 60 of rim cover 141 just inboard of lower edge 62. Fingers 151 and 151′ project upwardly from lower edge 62 and terminate with upper ends 152 and 152′, respectively, which upper ends 152 and 152′ are directed toward upper edge 61.

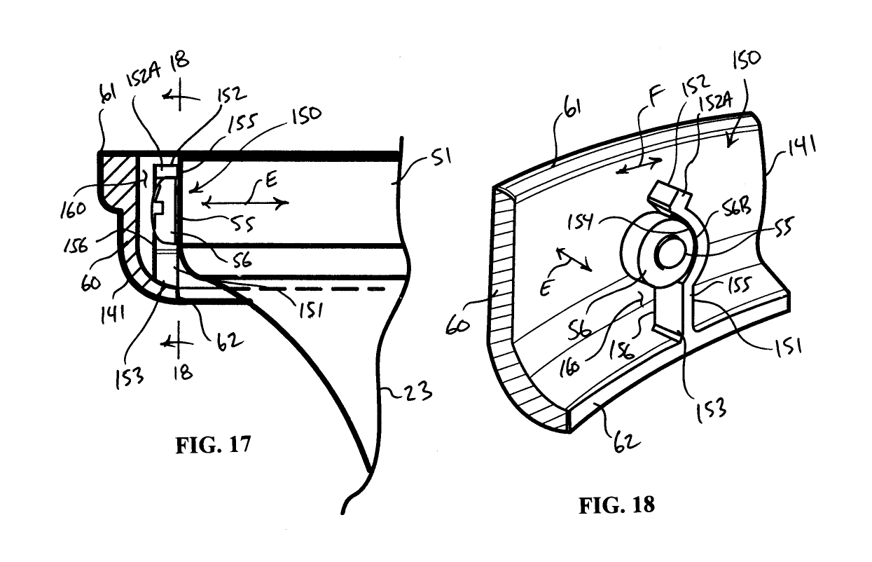

Rim cover 140 is generally circular in shape, and fingers 151 and 151′ are circumferentially spaced apart from each other and are further positioned to relate to the heads 56 of a pair of respective screws 55 securing canopy 23 to hanger bracket 21. Notches 154 and 154′ are formed in fingers 151 and 151′, respectively. Notch 154 is formed between upper and lower ends 152 and 153 of finger 151, and notch 154′ is formed between upper and lower ends 152′ and 153′ of finger 151′. Notches 154 and 154′ oppose and substantially face outwardly away from one another and are substantially equal in size. Finger 151 has opposed front and rear faces 155 and 156 denoted in FIG. 15, FIG. 17, and FIG. 18, and finger 151′ has opposed front and rear faces 155′ and 156′ denoted in FIG. 15. Rear faces 156 and 156′ face sidewall 60, in which there is a gap 160 therebetween rear face 156 and sidewall 60 illustrated in FIGS. 15 and 16, and a gap 160′ therebetween rear face 156′ and sidewall 60 illustrated in FIG. 15, FIG. 16, FIG. 17, and FIG. 18. Upper ends 152 and 152′ of fingers 151 and 151′ are formed with out turned portions 152A and 152A′. Out turned portions 152A and 152A′ are out turned with respect to notches 154 and 154′, respectively. Fingers 151 and 151′ are flexurally resilient in reciprocal directions relative to sidewall 60 of rim cover 141, each as indicated by a double arrowed line E in FIG. 14, FIG. 15, FIG. 16, FIG. 17, and FIG. 18, and are flexurally resilient in reciprocal directions substantially relative to each other, each as indicated by a double arrowed line F in FIG. 14, FIG. 15, FIG. 16, FIG. 18, and FIG. 19.

Referencing FIG. 19, fingers 151 and 151′ are located between heads 56 of screws 55, and heads 56 of screws 55 reside on either side of fingers 151 and 151′ of clamp 150, and reside within and are held within the notches 154 and 154′ in fingers 151 and 151′ of clamp 150 when hanger assembly 20 is assembled and secured to an overhead support member, in which notches 154 and 154′ are applied against inner sides 56B of the heads 56 of the respective screws 55. Accordingly, rim cover 141 is received is clamp engagement with heads 56 of screws 55 to secure rim cover 141 with respect to canopy 23. Fingers 151 and 151′ are spaced apart with respect to each other, and are positioned to correspond to the positioning of the heads 56 of the respective two screws 55 securing canopy 23 to hanger bracket 21, and are aligned with the heads 56 of the respective two screws 55 when fitting rim cover 141 about the upper rim 51 of canopy 23. The integral formation of sidewall 60 with lower ends 153 and 153′ of fingers 151 and 151′ supporting notches 154 and 154′ is preferred, but it will be understood that lower ends 153 and 153′ of fingers 151 and 151′ can be welded to sidewall 60, adhesively affixed to sidewall 60, or rigidly affixed to sidewall 60 in other ways.

FIG. 19 illustrate the heads 56 of the two screws 55 positioned on either side of fingers 151 and 151′, with fingers 151 and 151′ positioned between heads 56, and the inner sides 56BA of the heads 56 of the respective two screws positioned in or otherwise received by notches 154 and 154′ formed in the respective fingers 151 and 151′ engaging and embracing heads 56. FIG. 18 is an enlarged view illustrating head 56 of screw 55 located in notch 154 formed in finger 151. The flexural nature of fingers 151 and 151′ is thus provided in such a way that fingers 151 and 151′ bias away from each other and toward the inner sides 56B of the respective heads 56 biasing notches 154 and 154′ toward and against the inner sides 56B of the respective heads 56 when installed therewith for providing a clamping engagement or embracement of heads 56 by fingers 151 and 151′ located between heads 56, according to the principle of the invention. When rim cover 24 is clamp engaged with respect to upper rim 51 of canopy 23 such that clamps 150 are clamp engaged to the heads 56 of two screws 55, fingers 151 and 151′ of the clamp 150 are received in juxtaposition with respect to upper rim 51 of canopy 23 as illustrated in FIG. 15. This aspect is also illustrated in FIG. 17, which shows finger 151′ of clamp 150 clamp engaged to head 56 of screw 55, and finger 151′ of clamp 150 received in juxtaposition with respect to upper rim 51 of canopy 23.

Fingers 151 and 151′ of each clamp 150 are flexurally resilient in reciprocal directions to concurrently admit heads 56 of screws 55 on either side of fingers 151 and 151′ and into notches 154 and 154′ formed in fingers 151 and 151′, respectively, to embrace and secure heads 56 of screws 55. The flexural character of fingers 151 and 151′ allow them to flex inwardly and toward each other as needed for installing rim cover 141 to canopy 23 and removing rim cover 141 from canopy 141. Rim cover 141 is brought upwardly toward upper rim 51 of canopy 23 and is maneuvered to register fingers 151 and 151′ with the respective heads 56 of screws 55. The heads 56 of the respective screws 55 are initially received against out turned portions 152A and 152A′ of the respective fingers 151 and 151′. Through the application of an upward force, heads 56 of the respective screws 55 act on out turned portions 152A and 152A′ of fingers 151 and 151′, respectively, spreading fingers 151 and 151′ inwardly toward each other permitting the heads 56 of the respective screws 55 to pass between fingers 151 and 151′ to notches 154 and 154′, in which fingers 151 and 151′ then flex outwardly with respect to each other toward the inner sides 56B of the heads 56 of the respective screws 55 engaging notches 154 and 154′ of fingers 141 against the inner sides 56B of the heads 56 of the respective screws 55 clamping and embracing heads 56 on either side of fingers 151 and 151′ thereby clamping and securing heads 56 and clamp securing rim cover 141 with respect to upper rim 51 of canopy 23.

Like hanger assembly 20 illustrated in FIG. 2, when hanger assembly 140 is assembled and installed, upper edge 61 of rim cover 141 resides in juxtaposition with the ceiling. Further, lower edge 62 of rim cover 141 is in turned to reside in juxtaposition with canopy 141 as illustrated in FIG. 17.

Those of ordinary skill will readily appreciate that hanger assembly 140 may incorporate any number of screws 55 to secure canopy 23 to hanger bracket 21, and that rim cover 141 may be constructed with the appropriate number of clamps 150 to correspond the number of screws 55 hanger assembly 100 utilizes, with the understanding that each clamp 150 relates to two heads of two screws.

The present invention is described above with reference to preferred embodiments. However, those skilled in the art will recognize that changes and modifications may be made in the described embodiments without departing from the nature and scope of the present invention.

Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A hanger assembly for depending a fan from an overhead support, said hanger assembly comprising:
a mounting bracket securable to the overhead support;
a down rod to be suspended from the mounting bracket and having a lower end engagable with the fan;
a canopy having a central opening for receiving the down rod there through and having an upper rim;
mounting screws each extending through the rim of the canopy and engaged to the hanger bracket and having a head residing external of the rim of the canopy;
a rim cover for encapsulating the heads of the screws and securable with respect to the rim of the canopy;
opposed fingers each having a lower end affixed to the rim cover and an opposing upper end, a notch between the opposed upper and lower ends, and opposed front and rear faces;
a first gap between the opposed fingers extending from and between the upper ends of the fingers and the lower ends of the fingers;
a second gap between the rear faces of the fingers and the rim cover; and
the fingers flexurally resilient in reciprocal directions relative to each other to admit the head of one of the screws into the first gap and into the notches formed in the fingers to embrace and secure the head of the screw.

2. The hanger assembly of claim 1, in which the fingers are flexurally resilient in reciprocal directions relative to the rim cover.

3. The hanger assembly of claim 1, in which the rim cover includes an upper edge receivable in juxtaposition with the ceiling.

4. The hanger assembly of claim 1, in which the rim cover includes an in turned lower edge receivable in juxtaposition with the canopy.

5. A hanger assembly for depending a fan from an overhead support, said hanger assembly comprising:
a mounting bracket securable to the overhead support;
a down rod to be suspended from the mounting bracket and having a lower end engagable with the fan;
a canopy having a central opening for receiving the down rod there through and having an upper rim;
mounting screws each extending through the rim of the canopy and engaged to the hanger bracket and including a head residing external of the rim of the canopy;
a rim cover for encapsulating the heads of the screws and securable with respect to the rim of the canopy;
opposed fingers each having a lower end affixed to the rim cover and an opposing upper end, a notch between the opposed upper and lower ends, and opposed front and rear faces;
a gap between the rear face of each of the fingers and the rim cover; and
the fingers flexurally resilient to admit the heads of the screws into the notches of the respective fingers to embrace and secure the heads of the screws.

6. The hanger assembly of claim 5, in which the fingers are flexurally resilient in reciprocal directions relative to the rim cover.

7. The hanger assembly of claim 5, in which the rim cover includes an upper edge receivable in juxtaposition with the ceiling.

8. The hanger assembly of claim 5, in which the rim cover includes an in turned lower edge receivable in juxtaposition with the canopy.

9. A hanger assembly for depending a fan from an overhead support, said hanger assembly comprising:
a mounting bracket securable to the overhead support;
a down rod to be suspended from the mounting bracket and having a lower end engagable with the fan;
a canopy having a central opening for receiving the down rod there through and having an upper rim;
opposed mounting screws each extending through the rim of the canopy and engaged to the hanger bracket and including a head residing external of the rim of the canopy, the heads each having a side;
a rim cover for encapsulating the heads of the screws and securable with respect to the rim of the canopy;
opposed fingers each having a lower end affixed to the rim cover and an opposing upper end, a notch between the opposed upper and lower ends, and opposed front and rear faces;
a gap between the rear face of each of the fingers and the rim cover; and
the fingers flexurally resilient to concurrently admit the sides of the heads of the respective screws into the notches of the respective fingers to embrace and secure the heads of the screws.

10. The hanger assembly of claim 9, in which the fingers are flexurally resilient in reciprocal directions relative to the rim cover.

11. The hanger assembly of claim 9, in which the notches are directed away from each other and the sides of the screws further comprise outer sides of the screws.

12. The hanger assembly of claim 9, in which the notches are directed toward each other and the sides of the screws further comprise inner sides of the screws.

13. The hanger assembly of claim 9, in which the rim cover includes an upper edge receivable in juxtaposition with the ceiling.

14. The hanger assembly of claim 9, in which the rim cover includes an in turned lower edge receivable in juxtaposition with the canopy.
